(19) United States
(12) Patent Application Publication
(10) Pub. No.: US 2015/0012883 A1
(43) Pub. Date: Jan. 8, 2015

(54) METHOD AND APPARATUS FOR PROVIDING A TASK-BASED USER INTERFACE

(71) Applicant: Nokia Corporation, Espoo (FI)

(72) Inventors: Thomas Richard Kier, Scotts Valley, CA (US); Wesley Thierry, San Francisco, CA (US); Jiang Gao, Cupertino, CA (US)

(21) Appl. No.: 13/933,750

(22) Filed: Jul. 2, 2013

(51) Int. Cl. G06F 3/0482

(52) U.S. Cl. CPC G06F 3/0482
USPC 715/810

(57) ABSTRACT

A method, apparatus and computer program product are disclosed in order to provide a task-based user interface. In the context of a method, a plurality of tasks are identified based upon a context of a user or a user device. The method also determines an arrangement of the plurality of tasks, such as also based upon the context of the user or the user device. The method also causes an indication of each of the plurality of tasks to be displayed in accordance with the arrangement of the plurality of tasks. Once displayed, a selection of the indication of a respective task may be received with the task then being directly performed in response to the selection.

### TECHNOLOGICAL FIELD

An example embodiment of the present invention relates generally to a user interface of a computing device and, more particularly, to a task-based user interface of a computing device.

### BACKGROUND

Computing devices, such as mobile terminals or other user devices, may include a user interface to provide information to the user and, in some instances, to receive input from the user. For example, the user interface of a mobile terminal may present a home screen that includes a plurality of icons, each of which is associated with a respective application. In order to access an application, a user may select the icon associated with the application and the application may be launched. Typically, selection of an icon associated with an application may cause the home screen of the application to be presented from which a user may select a task to be performed. By way of example, an icon associated with a contacts database may be presented, along with icons associated with other applications, upon the home screen. Selection of the icon associated with the contacts database may cause the contacts application to be launched and the home screen of the contacts application to be presented. A user may then select a particular contact in order to view contact information associated with that contact or to place a call or send a message to the particular contact. Thus, while the home screen facilitates the launching of an application, a user must generally still provide a series of inputs in order to perform a task associated with the selected application.

In addition to home screens, computing devices, such as mobile terminals or other user devices, may also include one or more display panels that include widgets and/or status information. Thus, a user may quickly review the information provided by the widgets or the other status information by reference to the panel provided by the user interface.

A home screen or a panel that displays widgets or other status information is generally static in that the applications for which icons are provided by a home screen or the widgets or other status information that are presented by a display panel provided by the user interface remain the same and do not change absent an explicit edit operation performed by the user. Thus, the user must perform a predefined edit sequence in order to alter the applications for which icons are provided by the home screen or the widgets or other status information that is presented upon a display panel provided by the user interface. These edit sequences generally require a series of user inputs and, in some instances, may be somewhat cumbersome for the user as the edit sequences may not necessarily be intuitive.

### BRIEF SUMMARY

A method, apparatus and computer program product are provided according to an example embodiment in order to provide a task-based user interface. Thus, a user may cause a task to be performed in accordance with an example embodiment of the present invention in a more direct, intuitive and efficient manner from the perspective of the user. Additionally, the method, apparatus and computer program product of an example embodiment may identify the task for which an indication is displayed based upon the context of the user or user device and, in one embodiment, may also arrange the display of the indications of the plurality of tasks based upon the context of the user or the user device. As such, the method, apparatus and computer program product of this example embodiment may facilitate the user's identification of a task to be performed, thereby further increasing the efficiency with which a user may select a task from the user interface.

In an example embodiment, a method includes identifying, with a processor, a plurality of tasks based upon a context of a user or a user device. The method may also determine an arrangement of the plurality of tasks. The method may also cause an indication of each of the plurality of tasks to be displayed in accordance with the arrangement of the plurality of tasks. The method of one embodiment may also include receiving a selection of the indication of a respective task and directly performing the task in response to the selection. The method may also repeat the identification of the plurality of tasks, the determination of the arrangement and the causing of an indication of each of the tasks to be displayed so as to rearrange the plurality of tasks in an instance in which the context changes.

The method of an example embodiment may determine the arrangement of the plurality of tasks by determining a relevancy of each of the plurality of tasks and arranging the plurality of tasks based upon the relevancy of each of the plurality of tasks. In this embodiment, the method may determine the relevancy of each of the plurality of tasks based upon the context of the user or the user device upon which the indication of each of the plurality of tasks is displayed. In this regard, the method may determine the relevancy of the plurality of tasks based upon the context by determining the relevancy of the plurality of tasks based upon the time and/or the location of the user or the user device. The method may also or alternatively determine the relevancy of the plurality of tasks based upon the context by determining the relevancy of the plurality of tasks based upon historical interaction with the plurality of tasks.

In another embodiment, an apparatus is provided that includes at least one processor and at least one memory including computer program code with the at least one memory and the computer program code configured to, with the processor, cause the apparatus to at least identify a plurality of tasks based upon a context of a user or a user device. The at least one memory and the computer program code are also configured to, with the processor, cause the apparatus of this embodiment to determine the arrangement of the plurality of tasks and to cause an indication of each of the plurality of tasks to be displayed in accordance with the arrangement of the plurality of tasks. In one embodiment, the at least one memory and computer program code may be further configured to, with the processor, cause the apparatus to repeat the identification of the plurality of tasks, the determination of the arrangement and the causing of an indication of each of the tasks to be displayed so as to rearrange the plurality of tasks in an instance in which the context changes. The at least one memory and the computer program code may also be further configured to, with the processor, cause the apparatus of an example embodiment to receive a selection of the indication of a respective task and to directly perform the task in response to the selection.

The at least one memory and the computer program code may be configured to, with the processor, cause the apparatus of an example embodiment to determine the arrangement of the plurality of tasks by determining a relevancy of each of the plurality of tasks and arranging of the plurality of tasks based upon the relevancy of each of the plurality of tasks. In this embodiment, the determination of the relevancy may be based upon the context of the user or the user device upon which the indication of each of the plurality of tasks is displayed. In this regard, the at least one memory and the computer program code may be configured to, with the processor, cause the apparatus to determine the relevancy of the plurality of tasks based upon the context by determining the relevancy of the plurality of tasks based upon a time and/or a location of the user device. Additionally or alternatively, the at least one memory and computer program code may be configured to, with the processor, cause the apparatus to determine the relevancy of the plurality of tasks based upon the context by determining the relevancy of the plurality of tasks based upon historical interaction with the plurality of tasks.

In a further embodiment, a computer program product is provided that includes at least one non-transitory computer-readable storage medium having computer-executable program code portions stored therein with the computer-executable program code portions including program code instructions for identifying a plurality of tasks based upon a context of the user or a user device. The computer-executable program code portions also include program code instructions for determining an arrangement of the plurality of tasks and program code instructions for causing an indication of each of the plurality of tasks to be displayed in accordance with the arrangement of the plurality of tasks. The computer-executable program code portions of one embodiment may also include program code instructions for receiving a selection of the indication of a respective task and program code instructions for directly performing the task in response to the selection.

The program code instructions for determining an arrangement of the plurality of tasks may include program code instructions for determining a relevancy of each of the plurality of tasks and arranging the plurality of tasks based upon the relevancy of each of the plurality of tasks. In this regard, the program code instructions for determining of the relevancy of each of the plurality of tasks may include program code instructions for determining relevancy of the plurality of tasks based upon the context of the user or the user device upon which the indication of each of the plurality of tasks is displayed.

In yet another embodiment, an apparatus is provided that includes means for identifying a plurality of tasks based upon a context of a user or user device. The apparatus of this embodiment may also include means for determining an arrangement of the plurality of tasks and means for causing an indication of each of the plurality of tasks to be displayed in accordance with the arrangement of the plurality of tasks.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a schematic representation of a mobile terminal having a user interface that provides indications of a plurality of tasks in accordance with an example embodiment of the present invention;

FIG. 2 is a block diagram of an apparatus that may be specifically configured in accordance with an example embodiment of the present invention;

FIG. 3 is a flowchart illustrating the operations performed, such as by the apparatus of FIG. 2, in accordance with an example embodiment of the present invention;

FIG. 4 is a schematic representation of a mobile terminal having a user interface that provides indications of a plurality of tasks in accordance with another example embodiment of the present invention; and

FIG. 5 is a schematic representation of a mobile terminal having a user interface that provides indications of a plurality of tasks in accordance with yet another example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to provide a task-based user interface. In this regard, a method, apparatus and computer program product of an example embodiment may provide indications of a plurality of tasks to be displayed, such as upon the user interface of a user device, e.g., a computing device. A user may select one of the indications of a respective task so as to cause the task to be directly performed in response to the selection, thereby increasing the efficiency and the intuitive nature with which a task may be performed. The method, apparatus and computer program product may identify the plurality of tasks for which indications may be displayed based upon a context of the user or the user device. As such, the tasks for which indications may be presented may more likely be relevant to the user.

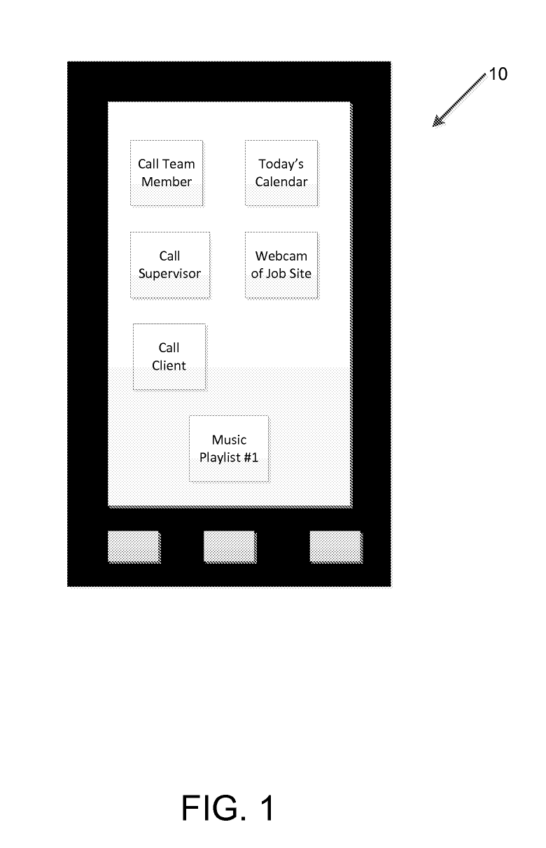

For example, FIG. 1 illustrates the user interface of a user device 10, such as a mobile terminal or other computing device, that displays the indications of a plurality of tasks that have been identified based upon the context of the user or the user device. In this example embodiment, the context of the user device may be work-related, such as related to a construction project with which the user is engaged. As such, a number of the tasks for which indications are provided relate to the current context of the user device, that is, a number of the tasks are generally work-related. As explained below, the indications of the tasks may also be arranged in accordance with an example embodiment of the present invention based upon the context of the user or the user device such that the tasks that are work-related in the embodiment of FIG. 1 may be presented more prominently, such as higher upon the user interface, than other non-work-related tasks.

The method, apparatus and computer program product may be embodied by or associated with a variety of different types of user devices including, for example, various types of mobile terminals, such as a portable digital assistant (PDA), mobile telephone, smartphone, pager, mobile television, gaming device, laptop computer, camera, tablet computer, headset, touch surface, video recorder, audio/video player, radio, electronic book, positioning device (e.g., global positioning system (GPS) device), or any combination of the aforementioned, and other types of voice and text communications systems. Additionally or alternatively, the user devices may be embodied by a fixed computing device, such as a personal computer, a workstation or the like or, in one embodiment, by a server or other computer that is remote from the user device that provides the user interface, but that performs the operations described below with respect to example embodiments of the present invention.

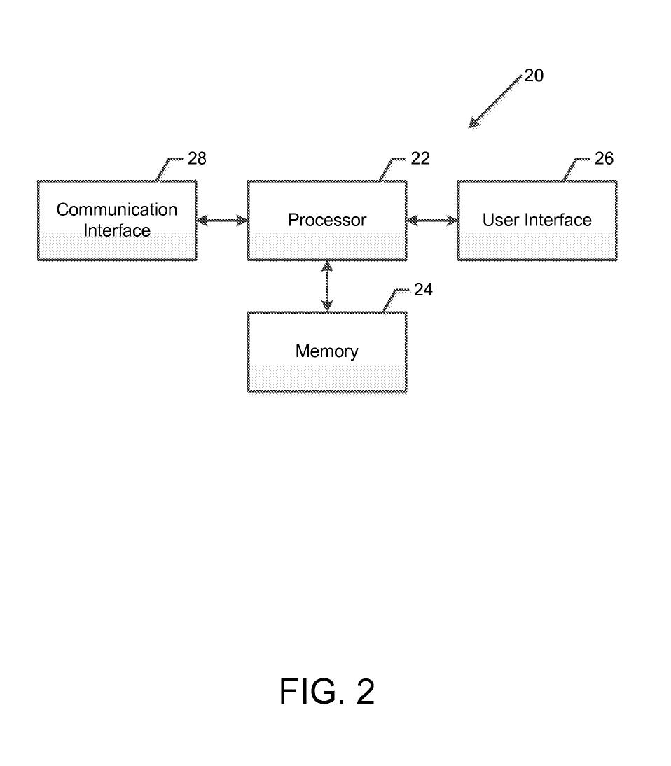

Regardless of the type of user device, the user device may include or otherwise be associated with an apparatus 20, such as that shown in FIG. 2, that is specifically configured in accordance with an example embodiment of the present invention to provide a task-based user interface. The apparatus may include or otherwise be in communication with a processor 22, a memory device 24, a communication interface 26 and optionally a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a user device, such as a mobile terminal or a fixed computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 26 may be any means such as a device or circuitry embodied in either hardware or a combination of hardware and software that is configured to receive and/or transmit data from/to a communications device 10 in communication with the apparatus 20, such as to facilitate communications between the communications devices as shown in FIG. 1. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, such as in instances in which the apparatus 20 is embodied by the user device, the apparatus includes a user interface 28 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a speaker, or other input/output mechanisms. In one embodiment, the user interface includes the display upon indications of a plurality of tasks are presented, as described below. Alternatively or additionally, the processor may comprise user interface circuitry configured to control at least some functions of one or more user interface elements such as a display and, in some embodiments, a speaker, ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

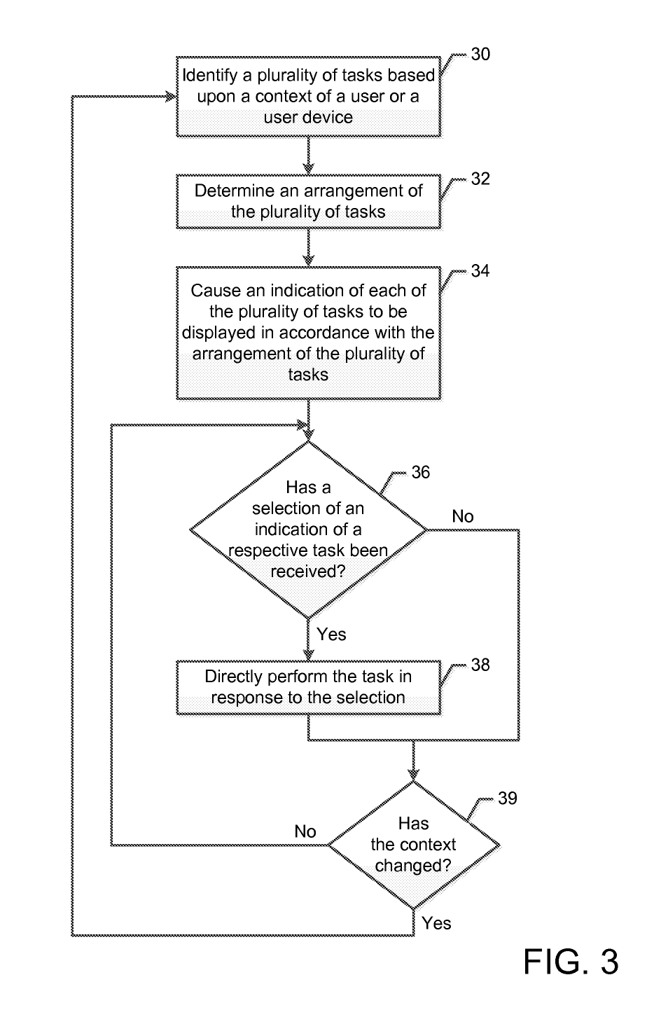

In order to provide for a task-based user interface 28, the operations performed, such as by the apparatus 20 of FIG. 2 embodied by or otherwise associated with a user device, in accordance with an example embodiment are illustrated in FIG. 3. As set forth by block 30 of FIG. 3, the apparatus may include means, such as the processor 22 or the like, for identifying a plurality of tasks based upon a context of the user of the user device or based upon the user device, that is, the computing device, itself. The context of the user or the user device may be determined by the processor in various manners. For example, the apparatus, such as the processor, may determine the context based upon the time, such as the time of day, the day of the week or the like. More particularly, the apparatus, such as the processor, of an example embodiment may determine the context to be work-related on Monday through Friday from 8 am until 5 pm. Similarly, the apparatus, such as the processor, may determine the context to be leisure related on Saturday and Sunday as well as after 5 pm on Monday through Friday.

Additionally or alternatively, the apparatus 20, such as the processor 22, may determine the context based upon the location of the user or the user device. In this regard, the apparatus, such as the processor, may determine the location of the user or the user device in various manners including by reliance upon a global positioning system (GPS) and/or upon Bluetooth or other proximity-based communication with other devices having a known location. In this embodiment, in an instance in which the apparatus, such as the processor, determines the location of the user or the user device to coincide with the user's place of business, the context of the user or the user device may be determined to be work-related. Alternatively, in an instance in which the apparatus, such as the processor, determines the location of the user or the user device to coincide with the user's home, the context of the user or the user device may be determined to be leisure-related.

While time and location have been provided as examples of the context of the user or the user device, the method, apparatus and computer program product of an example embodiment may define the context of the user or the user device in other manners in addition or instead of time and/or location. For example, the context of the user or the user device may be based upon the user's historical interaction with the tasks and/or upon user input.

As shown in block 32 of FIG. 2, the apparatus 20 may also include means, such as the processor 22 or the like, for determining an arrangement of the plurality of tasks that were identified based upon the context of the user or the user device. In an example embodiment, the apparatus, such as the processor, may determine the arrangement of the plurality of tasks by determining the relevancy of each of the plurality of tasks and arranging the plurality of tasks based upon the relevancy of each of the plurality of tasks. In this regard, the more relevant tasks may be arranged so as to be more prominently displayed, such as near an upper portion of the display, with a larger icon or the like. The apparatus, such as the processor, may determine the relevancy of the plurality of tasks in a variety of different manners.

For example, the relevancy of the plurality of tasks may be based upon the context of the user or the user device upon which the indication of each of the plurality of tasks is displayed. As described above, the context of the user or the user device may be defined in various manners including the time, e.g., time of day, day of the week, etc., the location of the user or the user device or the like. Additionally, or alternatively, the relevancy of the plurality of tasks may be based upon the historical interaction, such as by the user or otherwise via the user device, with the plurality of tasks. Thus, tasks with which the user has more frequently interacted may be considered more relevant than the tasks with which the user has less frequently interacted. Thus, the relevancy of the tasks may have a direct, e.g., proportional, relationship to the extent of historical interaction with the tasks.

The apparatus 20, such as the processor 22, may determine the historical interaction with the plurality of tasks independently of other parameters that may relate to relevancy, such as independent from time or location. Alternatively, the historical interaction with the plurality of tasks may be determined for the current time and/or the current location of the user or the user device. For example, in an instance in which the relevancy of the plurality of tasks is based upon both the location of the user or the user device and the historical interaction with the plurality of tasks, the apparatus, such as the processor, may initially determine the plurality of tasks that may be relevant based upon the location of the user or the user device. For those tasks that have been identified as being potentially relevant based upon the location of the user or the user device, the apparatus, such as the processor, may then determine the user's historical interaction with the plurality of tasks while at the respective location with the tasks with which the user more greatly interacts while at the respective location being determined to be more relevant and the tasks with which the user less frequently interacts while at the respective location being considered less relevant. Based upon the determination of the relevancy of each of a plurality of tasks, the apparatus, such as the processor, may then determine the arrangement of the plurality of tasks as described above with more relevant tasks generally being arranged so as to be presented in a more prominent manner than less relevant tasks.

As shown in block 34 of FIG. 3, the apparatus 20 may also include means, such as the processor 22, the user interface 28 or the like, for causing an indication of each of the plurality of tasks to be displayed in accordance with the arrangement of the plurality of tasks that has been determined. Various types of indications of the plurality of tasks may be displayed. As discussed hereinafter, the indications of the plurality of tasks may be provided by icons that are displayed in accordance with the arrangement of the plurality of tasks that has been determined. Alternatively, the indications of the plurality of tasks may be presented in the form of a list. Regardless of the type of indication that is representative of the respective tasks, the apparatus, such as the processor, the user interface or the like, may cause an indication of the plurality of tasks to be displayed based upon the relevancy of the plurality of tasks. For example, the tasks that have been identified to more relevant may be cause to be displayed in a more prominent manner, such as in an upper portion of the display, with larger icons or the like.

By way of example, FIG. 1 illustrates the user interface 28 of a mobile terminal in which the apparatus embodied by or otherwise associated with the mobile terminal and, more particularly, the processor, has determined the context to be work-related, such as based upon time and/or location. As such, the indications of the tasks that are work-related, e.g., call team member, today's calendar, call supervisor, web cam of the job site and call client, may be presented in an upper portion of the display. The indications of the tasks that are presented may include all of the tasks that relate to the respective context, such as all the tasks that are work-related. Alternatively, the indications of the tasks that are presented may be those tasks that are both related to the respective context, such as by being work-related, and that have historically been utilized more frequently by the user. In this regard, the apparatus 28, such as the processor 22, may determine the arrangement of the plurality of tasks such that not only are the tasks that are determined to be relevant are positioned in a prominent manner, but that from amongst the tasks that are relevant, the indications of the tasks are arranged such that the most relevant of the tasks are presented most prominently and the other tasks, all of which are relevant, are presented in a manner of less prominence. For example, the tasks associated with call team member and today's calendar may have been determined to be more relevant, such as by having been utilized more frequently by the user, than the task associated with call client, which remains relevant to the work-related context but less relevant based on historical utilization than the more prominently displayed tasks.

While each of the tasks for which indications are presented upon the user interface 28 may be relevant to the context, the indications of the tasks that are relevant to the respective context may not always fill the display. As such, indications of other tasks that are not necessarily relevant to the context may also be presented, albeit in a less prominent manner than the relevant tasks. For example, the apparatus 20, such as the processor 22, may determine the tasks that are unrelated to the context, but that are otherwise most frequently selected by the user. The apparatus, such as the processor, may then cause indications of the one or more of these unrelated tasks to also be displayed, albeit in a less prominent manner. With respect to the example of FIG. 1, the task associated with music play list #1 may be unrelated to the current context of the user or the user device, but may, in general, be frequently selected by the user and, as such, may be displayed in a less prominent manner, such as near the bottom of the display of the user interface.

Referring now to block 36 of FIG. 3, the apparatus 20 may also include means, such as the processor 22, the user interface 28 or the like, for determining whether a selection of the indication of a respective task has been received. For example, in an instance in which the user interface includes a touch screen display, a user may select the indication of a respective task by tapping the icon associated with the respective task. As such, the apparatus may include means, such as the processor, the user interface or the like, for receiving the selection of the indication of a respective task. In an instance in which a selection of the indication of a respective task has been received, the apparatus may also include means, such as the processor or the like, for directly performing the task in response to the selection. See block 38 of FIG. 3. In this regard, the selection of the task may cause the task to be directly performed without further input or interaction with the user. This direct performance of a task is in contrast to the execution of an application in response to the selection of an application, such as from a home screen. In this regard, an application would generally be represented by a single icon on the home screen with the selection of icon associated with the application causing the application to be launched and a home screen associated with the application to be presented, but the user would be required to provide one or more inputs or selections in order to perform any particular task provided by the application. For example, the selection of a contacts application may cause the contacts application to be launched and the home screen of the contacts application to be displayed, but the user would then be required to select a particular contact from the contacts database and, in some instances, to also select the desired mode of communication in order to attempt to communicate with the respective contact. As another example, the selection of an email application may cause the email application to be launched with the user thereafter being required to navigate through the user's accounts and folders to locate the email in which the user is interested.

In contrast, a plurality of indications associated with different tasks for the same application may be presented. In regards to the foregoing email example, indications may be provided for each of work email representative of the inbox for the user's work email account, gmail representative of the inbox for the user's personal email account, inbox representative of all emails from all accounts and email <person name> in which <person name> is the name of a person in the user's contacts database. As such, indications of the tasks permit multiple entry points to invoke the same application. As such, the selection of a respective task may cause the task to be directly performed without further user input, thereby increasing the efficiency with which the user may interact with the various tasks. With respect to the example of FIG. 1, the selection of the tasks identified as call team member, call supervisor or call client may cause calls to be placed to the team member, supervisor or client, respectively. Additionally, the selection of the task associated with today's calendar does not just open the calendar application, but, instead, opens the page of the calendar application dedicated to today's date such that the user may quickly determine their appointments or schedule for the day. Still further, the selection of the webcam of job site task may not just open a general video application via which the video provided by a webcam could be viewed, but launches the video captured by the webcam of the job site directly.

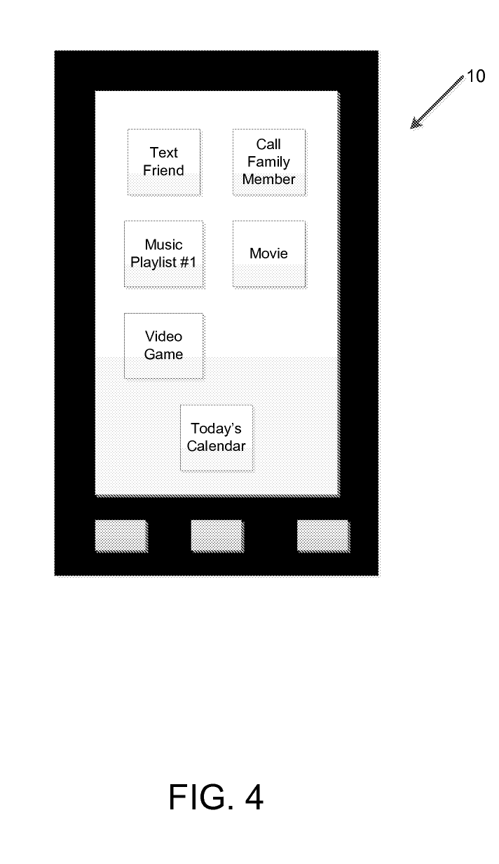

By way of another example, FIG. 4 depicts the user interface of a mobile terminal 10 in which the user or the user device has a context that is no longer work-related, but is associated with leisure time. As such, the indications of the tasks that are presented upon the display of the user interface have been rearranged based upon the current context of the user of the user device with those tasks that are more relevant to the current context being positioned in a more prominent manner. In this regard, the tasks associated with call team member, call supervisor and call client and the task associated with the webcam of the job site are no longer presented and, instead, tasks that are more frequently performed or are more frequently selected by the user during their leisure time are presented including the tasks associated with text friend, call family member, movie or video games. In this regard, the tasks associated with movie and video games identify a particular movie and a particular video game that may be directly performed in response to selection of the respective task. Additionally, the icon associated with today's calendar is still presented, but is less prominent than in the embodiment of FIG. 1 in which the context is work-related since the user may view today's calendar less frequently when at home than when at work.

Thus, as illustrated in FIG. 4 and as shown in block 39 of FIG. 3, the apparatus 20 may include means, such as the processor 22, the user interface 28 or the like, for determining if the context associated with the user or the user device has changed from the context utilized in the identification of the plurality of tasks that are currently presented by the user device. In an instance in which the context has changed, the apparatus, such as the processor, the user interface or the like, may repeat the identification of the plurality of tasks, the determination of the arrangement and the causing of an indication of each of the tasks to be displayed so as to rearrange the plurality of tasks in an instance in which the context changes. Thus, the apparatus, such as the processor, the user interface or the like, may cause the indications of the plurality of tasks that are presented to be updated and rearranged in an instance in which the context changes, thereby increasing the ease and efficiency with which the user may interact with the user device and select respective tasks. Alternatively, in an instance in which the context has not changed, the apparatus, such as the processor, the user interface or the like, may continue to present indications of the same tasks that were previously identified as being relevant to the correct context.

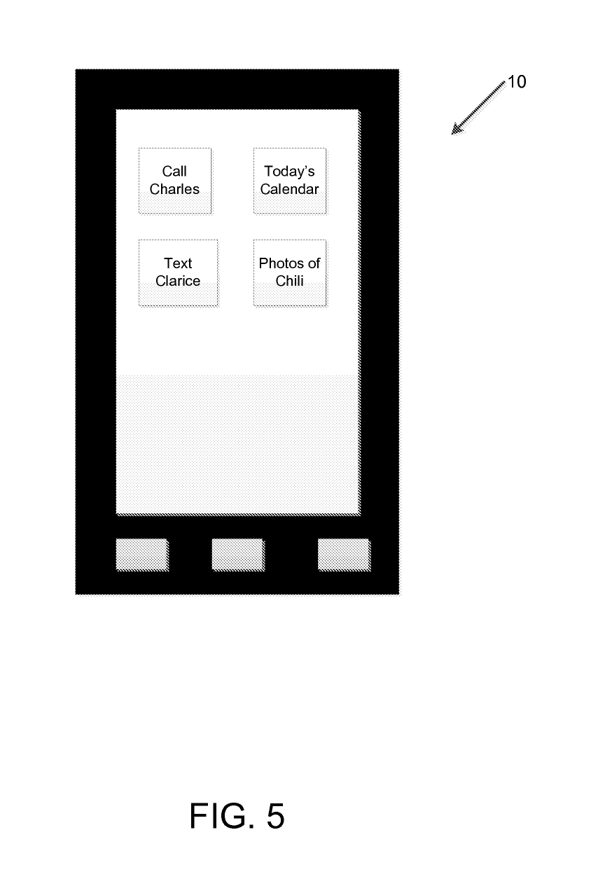

In an instance in which indications of the plurality of tasks have been displayed with in accordance with the arrangement that has been determined for the tasks, user input may be received that does not select one of the tasks, but which, instead, redefines or refines the relevancy of the tasks (either all of the tasks in one embodiment or those tasks for which indications were previously provided in another embodiment). Based upon this user input redefining the relevancy of the tasks, the arrangement of the tasks may be similarly redefined such that display of the indications of the plurality of tasks may be updated in accordance with the redefined arrangement. For example, the user may provide user input in the form of a one or more alphanumeric characters such that tasks that include or otherwise associated with the alphanumeric characters are identified and have increased relevance. As such, the tasks may be filtered based upon the user input then presented upon the display with the indications of those tasks that satisfy the user input being presented with increased prominence. For example, FIG. 5 depicts the user interface 28 of a mobile terminal 10 in which a user has provided input in the form of the letter “c”. As such, the apparatus 20, such as the processor 22, has identified those tasks that include or otherwise are associated with the letter “c” and, therefore, are relevant to the user input. The example tasks may include call Charles, today's calendar, text Clarice, and photos of Chile. As such, the relevancy of the plurality of tasks are redefined such that the indications of the tasks may be rearranged in accordance with the user input. Consequently, the method, apparatus and computer program product of an example embodiment permit a user to interact with a plurality of tasks, such as by causing a selected task to be directly performed, in a manner that is both efficient and intuitive.

As described above, FIG. 3 illustrates a flowchart of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. The computer program product may be embodied as an application that is configured to implement, for example, at least certain ones of the operations of the flowchart of FIG. 4.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
identifying, with a processor, a plurality of tasks based upon a context of a user or a user device;
determining an arrangement of the plurality of tasks; and
causing an indication of each of the plurality of tasks to be displayed in accordance with the arrangement of the plurality of tasks.

2. A method according to claim 1 further comprising:
receiving a selection of the indication of a respective task; and
directly performing the task in response to the selection.

3. A method according to claim 1 wherein determining an arrangement of the plurality of tasks comprises determining a relevancy of each of the plurality of tasks and arranging the plurality of tasks based upon the relevancy of each of the plurality of tasks.

4. A method according to claim 3 wherein determining a relevancy of each of the plurality of tasks comprises determining the relevancy of the plurality of tasks based upon the context of the user or the user device upon which the indication of each of the plurality of tasks is displayed.

5. A method according to claim 4 wherein determining the relevancy of the plurality of tasks based upon the context comprises determining the relevancy of the plurality of tasks based upon a time.

6. A method according to claim 4 wherein determining the relevancy of the plurality of tasks based upon the context comprises determining the relevancy of the plurality of tasks based upon a location of the user or the user device.

7. A method according to claim 4 wherein determining the relevancy of the plurality of tasks based upon the context comprises determining the relevancy of the plurality of tasks based upon historical interaction with the plurality of tasks.

8. A method according to claim 1 further comprising repeating the identifying of the plurality of tasks, the determining of the arrangement and the causing of an indication of each of the tasks so as to rearrange the plurality of tasks in an instance in which the context changes.

9. An apparatus comprising:
at least one processor and at least one memory including computer program code, the at least one memory and the computer program code configured to, with the processor, cause the apparatus to at least:
identify a plurality of tasks based upon a context of a user or a user device;
determine an arrangement of the plurality of tasks; and
cause an indication of each of the plurality of tasks to be displayed in accordance with the arrangement of the plurality of tasks.

10. An apparatus according to claim 8 wherein the at least one memory and the computer program code are further configured to, with the processor, cause the apparatus to:
receive a selection of the indication of a respective task; and
directly perform the task in response to the selection.

11. An apparatus according to claim 9 wherein the at least one memory and the computer program code are configured to, with the processor, cause the apparatus to determine an arrangement of the plurality of tasks by determining a relevancy of each of the plurality of tasks and arranging the plurality of tasks based upon the relevancy of each of the plurality of tasks.

12. An apparatus according to claim 11 wherein the at least one memory and the computer program code are configured to, with the processor, cause the apparatus to determine a relevancy of each of the plurality of tasks by determining the relevancy of the plurality of tasks based upon the context of the user or the user device upon which the indication of each of the plurality of tasks is displayed.

13. An apparatus according to claim 12 wherein the at least one memory and the computer program code are configured to, with the processor, cause the apparatus to determine the relevancy of the plurality of tasks based upon the context by determining the relevancy of the plurality of tasks based upon a time.

14. An apparatus according to claim 12 wherein the at least one memory and the computer program code are configured to, with the processor, cause the apparatus to determine the relevancy of the plurality of tasks based upon the context by determining the relevancy of the plurality of tasks based upon a location of the user or the user device.

15. An apparatus according to claim 12 wherein the at least one memory and the computer program code are configured to, with the processor, cause the apparatus to determine the relevancy of the plurality of tasks based upon the context by determining the relevancy of the plurality of tasks based upon historical interaction with the plurality of tasks.

16. An apparatus according to claim 9 wherein the at least one memory and the computer program code are further configured to, with the processor, cause the apparatus to repeat the identifying of the plurality of tasks, the determining of the arrangement and the causing of an indication of each of the tasks so as to rearrange the plurality of tasks in an instance in which the context changes.

17. A computer program product comprising at least one non-transitory computer-readable storage medium having computer-executable program code portions stored therein, the computer-executable program code portions comprising program code instructions for:
identifying a plurality of tasks based upon a context of a user or a user device;
determining an arrangement of the plurality of tasks; and
causing an indication of each of the plurality of tasks to be displayed in accordance with the arrangement of the plurality of tasks.

18. A computer program product according to claim 17 wherein the computer-executable program code portions further comprise program code instructions for:
receiving a selection of the indication of a respective task; and
directly performing the task in response to the selection.

19. A computer program product according to claim 17 wherein the program code instructions for determining an arrangement of the plurality of tasks comprise program code instructions for determining a relevancy of each of the plurality of tasks and arranging the plurality of tasks based upon the relevancy of each of the plurality of tasks.

20. A computer program product according to claim 19 wherein the program code instructions for determining a relevancy of each of the plurality of tasks comprise program code instructions for determining the relevancy of the plurality of tasks based upon the context of the user or the user device upon which the indication of each of the plurality of tasks is displayed.
